(19) United States
(12) Patent Application Publication
(10) Pub. No.: US 2026/0031644 A1
(43) Pub. Date: Jan. 29, 2026

(54) Multi-Port Output Control Circuit, Power Circuit, And Charging Apparatus

(71) Applicant: Anker Innovations Technology Co., Ltd., Changsha (CN)

(72) Inventors: Yijin Qiu, Shenzhen (CN); Qianer Xu, Shenzhen (CN)

(21) Appl. No.: 19/272,287

(22) Filed: Jul. 17, 2025

(30) Foreign Application Priority Data
Jul. 25, 2024 (CN) 202421785436.1

(51) Int. Cl. H02J 7/00; H01R 24/60; H02J 7/06; H02M 7/12

(52) U.S. Cl. CPC H02J 7/00712; H01R 24/60; H02J 7/06; H02M 7/12; H02J 2207/20

(57) ABSTRACT

The present application discloses a multi-port output control circuit, a power circuit, and a charging apparatus. The multi-port output control circuit comprises N output control modules, M transformer modules, and a controller. Each of the output control modules comprises an output port configured to be connected to an external device. Each of the transformer modules is connected to at least two output control modules, wherein M<N. The controller is connected to each of the output control modules to control the output control modules. Based on a number of external devices simultaneously connected to the output ports not exceeding M, the transformer modules are configured to supply power to the external devices through the output control modules.

### CROSS-REFERENCE TO RELATED APPLICATION

The present disclosure claims priority of CN Application No. 202421785436.1, filed Jul. 25, 2024, before the China National Intellectual Property Administration, which is incorporated herein by reference in its entirety.

### TECHNICAL FIELD

The present application relates to the field of charging apparatuses, specifically to a multi-port output control circuit, a power circuit, and a charging apparatus.

### BACKGROUND

With the growing prevalence of smart devices in daily life, the demand for efficient charging has increased significantly. devices such as smart phones, laptops, and tablets, as well as electric tools, cordless vacuum cleaners, and vehicle-mounted vacuum cleaners that support mainstream fast charge protocols all require fast charging. Therefore, multi-port charging apparatuses have evolved from technologies for single-port charging devices.

In related technologies, in order to fast charge an external device through a multi-port charging apparatus, the external device often needs to be connected to a corresponding fast charging interface. However, the multi-port charging apparatus has many interfaces, making it difficult for a user to find the corresponding fast charging interface to charge the external device, and causing inconvenience to the user accordingly.

### SUMMARY

The present application provides a multi-port output control circuit, a power circuit, and a charging apparatus, aiming to improve user convenience by connecting external devices to any of the output ports and fast charging the external devices through the charging apparatus when the quantity of external devices that a user needs to charge is at most the same as that of transformer modules, without selecting corresponding output ports according to instructions or labels.

An example of the present application provides a multi-port output control circuit, applicable to a power circuit, where the multi-port output control circuit comprises N output control modules, M transformer modules, and a controller. Each of the output control modules comprises an output port configured to be connected to an external device. Each of the transformer modules is connected to at least two output control modules, where M<N. The controller is connected to each of the output control modules. Based on a number of external devices simultaneously connected to the output ports not exceeding M, the transformer modules are configured to supply power to the external devices through the output control modules.

Based on the above example, when at most M external devices are simultaneously connected to M output ports, the charging apparatus can fast charge each external device to improve the charging efficiency of each external device. In addition, when a user needs to charge at most M external devices, the external devices can be connected to any of the output ports and can be fast charged through the charging apparatus without selecting corresponding output ports according to the instructions or labels, thereby improving user convenience.

An example of the present application further provides a power circuit, comprising a rectifier module, the multi-port output control circuit, and a protocol chip, where the rectifier module has an alternating current input terminal and a direct current output terminal, and the alternating current input terminal of the rectifier module is used for being connected to mains power (e.g., a power source). An input terminal of the transformer module is connected to the direct current output terminal of the rectifier module. The protocol chip is connected to the transformer module and the output port.

An example of the present application further provides a charging apparatus, comprising a shell, a circuit board, and the power circuit, where the shell has a mains interface (e.g., a power interface). The circuit board is disposed inside the shell. The power circuit is disposed on the circuit board, the alternating current input terminal of the rectifier module is connected to the mains interface, and the output port is disposed on the shell and exposed.

Based on the multi-port output control circuit of the present application, when at most M output ports are connected to external devices, the controller controls the conduction of the output control modules corresponding to the output ports that are connected to the external devices, so that the transformer modules can supply power to the external devices in the fast charging mode through the output control modules, and when at most M external devices are simultaneously connected to M output ports, the charging apparatus can fast charge each external device to improve the charging efficiency of each external device. In addition, when a user needs to charge at most M external devices, the external devices are connected to any output ports and can be fast charged through the charging apparatus, and the user does not need to select corresponding output ports according to the instructions or labels, thereby improving user convenience.

### BRIEF DESCRIPTION OF THE DRAWINGS

To describe the technical solutions in the present application or in the prior art more clearly, the following briefly introduces the accompanying drawings for describing the application. Apparently, the accompanying drawings in the following description show only some examples of the present application, and those skilled in the art can derive other drawings from the accompanying drawings without any creative efforts.

FIG. 1 is a schematic structural diagram of a charging apparatus in an example of the present application;

FIG. 2 is a schematic diagram of a framework structure of a power circuit in an example of the present application;

FIG. 3 is a schematic structural diagram of a multi-port output control circuit in an example of the present application; and

FIG. 4 is a schematic structural diagram of a multi-port output control circuit in another example of the present application.

Explanation of reference numerals: 1. Charging apparatus; 11. Shell; 12. Circuit board; 2. Power circuit; 21. Rectifier module; 22. Protocol chip; 3. Multi-port output control circuit; 31. Output control module; 31A. Output port; 311. Control sub-circuit; 3111. First switch circuit; 3112. Second switch circuit; 32. Transformer module; 33. Controller; Q1. First switch element; Q2. Second switch element; Q3. Third switch element; R1. First resistor; R2. Second resistor; R3. Third resistor; D1. First diode; D2. Second diode.

### DETAILED DESCRIPTION

In order to make the objectives, technical solutions, and advantages of the present application clearer, the following further describes the present application in detail in conjunction with the accompanying drawings and examples. It should be understood that the specific examples described herein are merely used for explaining the present application, but not for limiting the present application.

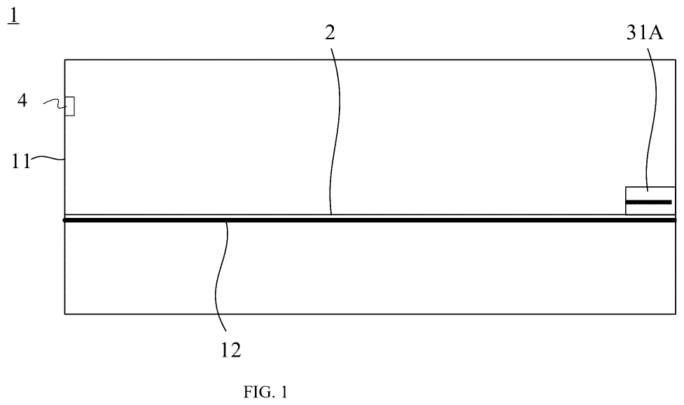

With reference to FIG. 1, an example of the present application provides a charging apparatus 1, including a shell 11, a circuit board 12, and a power circuit 2.

The shell 11 can support and protect electronic components by covering the electronic components disposed inside the shell 11. The material of the shell 11 may be plastic or metal. Specifically, the material of the shell 11 may be plastic to insulate the shell 11 from electric current, thereby reducing the risk of electric shock for users. Because plastic is relatively light, the shell 11 is also light, making the overall charging apparatus 1 light for users to carry and use. Specifically, the shell 11 may be integrally injection-molded to have high structural strength, making it less prone to damage, protecting other components inside the shell 11 to reduce the probability of damage, and allowing the charging apparatus 1 to have a relatively long service life.

The shell 11 may further have a mains interface 4, and the mains interface 4 is configured to be connected to mains power (e.g., external power source, AC power, wall outlet). The power circuit 2 can be formed on the circuit board 12 through an etching process, thereby improving the production efficiency of the power circuit 2 and reducing the production cost of the power circuit 2. It can be understood that the charging apparatus 1 may be a portable power source or a charger, and the specific form of the charging apparatus 1 is not limited in the present application.

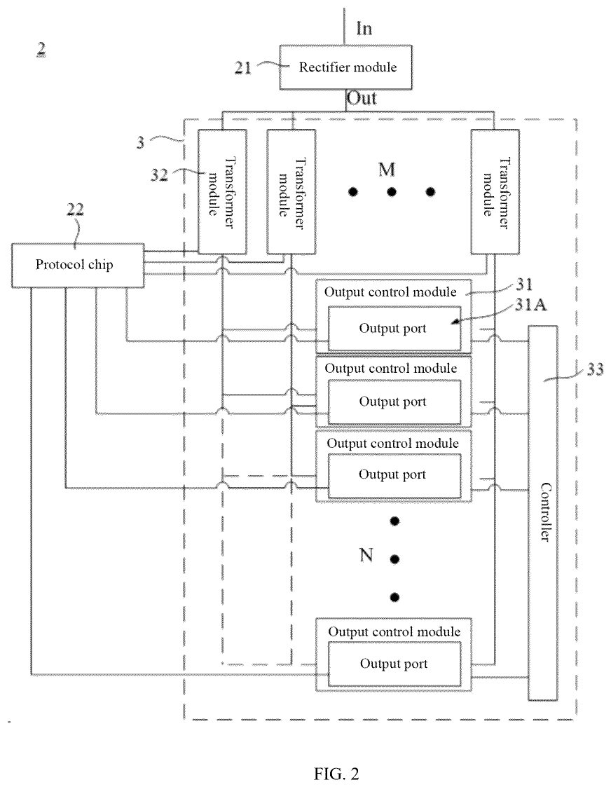

With reference to FIG. 2, the power circuit 2 may include a rectifier module 21, a multi-port output control circuit 3, and a protocol chip 22.

The rectifier module 21 has an alternating current (AC) input terminal In and a direct current (DC) output terminal Out. The AC input terminal In of the rectifier module 21 can be connected to the mains interface 4 of the shell 11, and the DC output terminal Out of the rectifier module 21 is connected to the multi-port output control circuit 3.

For example, the rectifier module 21 may include a rectifier circuit, a filter circuit, and a voltage regulator circuit. The rectifier circuit is used to rectify (e.g., convert) AC into DC, and the rectifier circuit may include a bridge rectifier circuit or a pulse width modulation (PWM) rectifier circuit. The filter circuit is configured to filter the pulsating DC output by the rectifier circuit, so as to smooth the waveform of the output DC. The voltage regulator circuit is configured to maintain a constant output voltage. The specific form of the rectifier module 21 is not limited.

With reference to FIG. 2, in an example of the present application, the multi-port output control circuit 3 may include an output control module 31, a transformer module 32, and a controller 33. The output control module 31 may include an output port 31A. The output port 31A is configured to be connected to an external device, and the output port 31A is also configured to be connected to the shell 11 and exposed via the shell 11, facilitating connection between the external device and the output port 31A. The charging apparatus 1 may be connected to mains power and supply power to the external device via the output port 31A. The external device may include, but is not limited to, a mobile phone, earphones, a tablet, or a smart watch. The output port 31A may include at least one of a USB-A interface, a Micro USB interface, a USB Type-C interface, or a Lightning interface.

The transformer module 32 is configured to boost or buck the DC output by the rectifier module 21, and supply power to the output control module 31, so that the output port 31A outputs a corresponding voltage. Specifically, the protocol chip 22 may be connected to the output port 31A and the transformer module 32. After the external device is connected to the corresponding output port 31A, the protocol chip 22 exchanges information with the external device through the output port 31A. The content of information exchange may include the remaining power of the external device and rated charging power of the external device. Afterwards, the protocol chip 22 can output power parameter information corresponding to the external device to the transformer module 32. The transformer module 32 can output charging power required by the external device based on the power parameter information, thereby achieving the matching of the output power of the power circuit 2 with the external device. The above process can be referred to as handshake communication between the charging apparatus 1 and the external device in some examples.

For example, the fast charge protocol supported by the protocol chip 22 includes at least one of a USB PD (Power Delivery) fast charge protocol, a QC (Quick Charge) protocol, an FCP (Fast Charge Protocol), an SCP (Super Charge Protocol), and a Mi Turbo Charge protocol. In some examples, the fast charge protocol supported by the protocol chip 22 can further include other types, which can be selected according to the scope of application of a product. The fast charging mode involved in the present application is a charging mode that matches the output port 31A with the fast charge protocol.

In order to adapt to the above fast charge protocol and market demand, the output port 31A in the present application is illustrated by USB Type-C as an example.

The controller 33 may be connected to the output control module 31, and may be configured to control the conduction of the output control module 31 (e.g., control the switching state of the output control module to selectively allow current to flow therethrough), thereby enabling the transformer module 32 to supply power to the external device via the enabled output control module 31.

In the examples of the present application, the multi-port output control circuit 3 may include N output control modules 31 and M transformer modules 32, where N≥2. Each output control module 31 may include an output port 31A; each transformer module 32 may be connected to at least two output control modules 31, where 1≤M<N; and the controller 33 may be connected to the N output control modules 31.

If at most M output ports 31A are connected to external devices, the controller 33 is configured to control the conduction of the corresponding output control modules 31, so that the transformer modules 32 can supply power to the external devices in a fast charging mode through the output control modules 31, and when at most M external devices are simultaneously connected to M output ports 31A, the charging apparatus 1 can fast charge each external device to improve the charging efficiency of each external device. In addition, when a user needs to charge at most M external devices, the external devices are connected to any output ports 31A and can be fast charged through the charging apparatus 1, and the user does not need to select corresponding output ports 31A according to instructions or labels, thereby improving user convenience.

In an example, the quantity of transformer modules 32 is less than that of output control modules 31 (e.g., M<N), so that the quantity of the transformer modules 32 in the charging apparatus 1 can be reduced, and the transformer modules 32 occupy a small space in the shell 11, making the overall volume of the charging apparatus 1 small and making it easier to carry and use the charging apparatus 1. Furthermore, the small quantity of transformer modules 32 can reduce the overall cost of the charging apparatus 1.

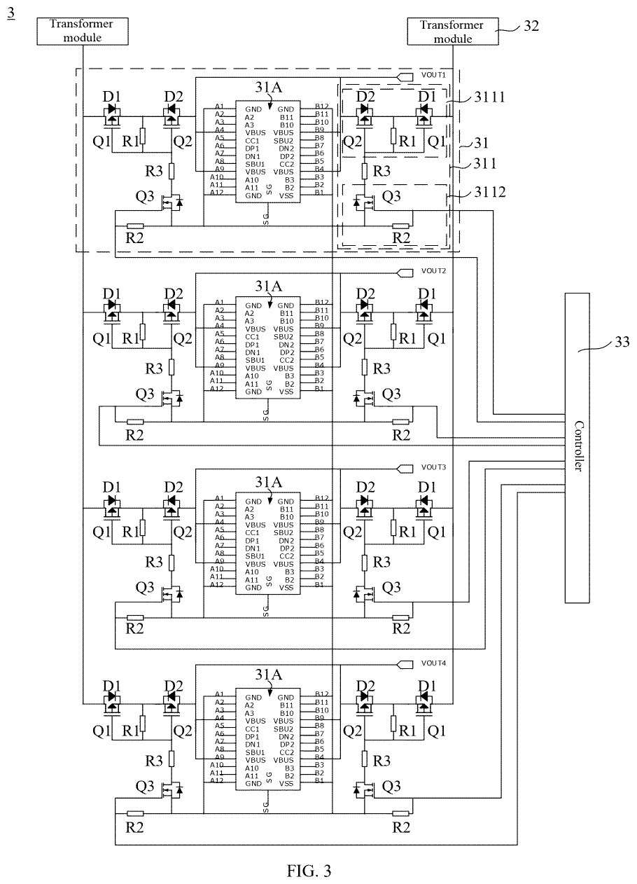

With reference to FIG. 2 and FIG. 3, in an example, each output control module 31 may further include a control sub-circuit 311, and the control sub-circuit 311 is connected to the output port 31A, the transformer module 32, and the controller 33. Based on that the charging apparatus 1 detects that the corresponding output port 31A is connected to an external device, the controller 33 is configured to control the conduction of the preset control sub-circuit 311, so that the transformer module 32 can supply power to the output port 31A via the control sub-circuit 311, and the output port 31A can supply power to the external device.

It can be understood that the quantity of control sub-circuits 311 in the output control module 31 may be one, two, three, or the like. Each control sub-circuit 311 can be connected to a respective (e.g., different) transformer module 32, so that each output port 31A can correspond to at least one transformer module 32. Therefore, when at least one transformer module 32 does not supply power to the outside, the controller 33 can control the conduction of the control sub-circuit 311 corresponding to the transformer module 32 (e.g., enter a conducting state), so that the transformer module 32 can supply power to the output port 31A via the control sub-circuit 311 to fast charge the external device, thereby increasing the probability that the output port 31A can fast charge the external device, improving the charging experience of users, and also improving the charging efficiency of the external device.

In an example, when N=2 and M=1, the multi-port output control circuit 3 may include two output control modules 31 and one transformer module 32, where each control module 311 may include one control sub-circuit 311, and the two control sub-circuits 311 are connected to the transformer module 32. When one of the output ports 31A is connected to an external device, the controller 33 is configured to control the conduction of the control sub-circuit 311 corresponding to the output port 31A that is connected to the external device, so that the transformer module 32 can supply power to the external device in the fast charging mode through the output control module 31.

With reference to FIG. 2 and FIG. 3, in another example, when N=4 and M=2, the multi-port output control circuit 3 may include four output control modules 31 and two transformer modules 32, where each output control module 31 includes two control sub-circuits 311, and the two control sub-circuits 311 are connected to the output ports 31A and the controller 33 and connected to the two transformer modules 32 respectively.

Specifically, two of the four output ports 31A are selected as a first output port and a second output port respectively. When the first output port is connected to an external device, the controller 33 is configured to control the conduction of the control module 311 corresponding to the first output port, so that one transformer module 32 supplies power to the first output port via the control module 311, thereby enabling the first output port to supply power to the external device in the fast charging mode.

When the second output port is connected to an external device, the controller 33 is configured to control the conduction of the control module 311 corresponding to the second output port, so that another transformer module 32 can supply power to the second output port via the control module 311, thereby enabling the second output port to supply power to the external device in the fast charging mode. When at least two output ports 31A are connected to external devices, the controller 33 is configured to control the conduction of the output control modules 31 corresponding to the output ports 31A that are connected to the external devices, so that the transformer modules 32 can supply power to the external devices in the fast charging mode through the output control modules 31.

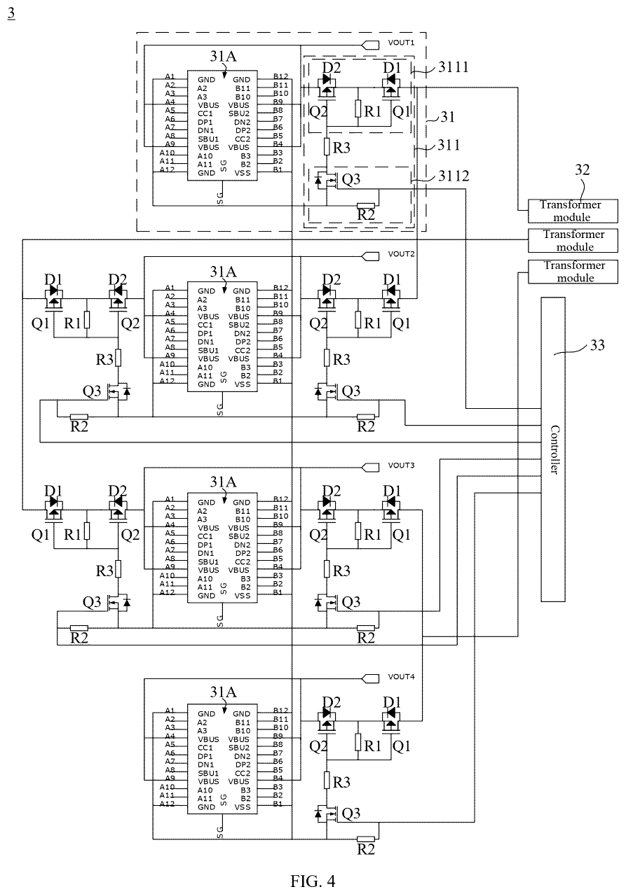

With reference to FIG. 2 and FIG. 4, in another example, when N=4 and M=3, the multi-port output control circuit 3 may include four output control modules 31 and three transformer modules 32, where the four output control modules 31 are respectively a first output control module, a second output control module, a third output control module, and a fourth output control module (as shown in FIG. 4, a first output control module, a second output control module, a third output control module, and a fourth output control module from top to bottom). The first output control module and the fourth output control module may each have a control sub-circuit 311. The second output control module and the third output control module may each have two control sub-circuits 311. The three transformer modules 32 are respectively a first transformer module, a second transformer module, and a third transformer module (as shown in FIG. 4, a first transformer module, a second transformer module, and a third transformer module from top to bottom). The first transformer module is connected to the control sub-circuit 311 of the first output control module and one control sub-circuit 311 in the second output control module; the second transformer module is connected to the other control sub-circuit 311 in the second output control module and one control sub-circuit 311 in the third output control module; and the third transformer module is connected to the other control sub-circuit 311 in the third output control module and the control sub-circuit 311 of the fourth output control module.

With reference to FIG. 2 and FIG. 4, for example, three output ports from top to bottom are selected from four output ports 31A, respectively a first output port, a second output port, and a third output port. When the first output port is connected to an external device, the controller 33 is configured to control the conduction of the control module 311 corresponding to the first output port, so that the first transformer module supplies power to the first output port via the control module 311, thereby enabling the first output port to supply power to the external device in the fast charging mode.

When the second output port is connected to an external device, the controller 33 is configured to control the conduction of the control module 311 corresponding to the second output port, so that the second transformer module can supply power to the second output port via the control module 311, thereby enabling the second output port to supply power to the external device in the fast charging mode.

When the third output port 31A is connected to an external device, the controller 33 is configured to control the conduction of the control module 311 corresponding to the third output port 31A, so that the third transformer module can supply power to the third output port 31A via the control module 311, thereby enabling the third output port 31A to supply power to the external device in the fast charging mode.

Similarly, when at least three output ports 31A are connected to external devices, the controller 33 is configured to control the conduction of the output control modules 31 corresponding to the output ports 31A that are connected to the external devices, so that the transformer modules 32 can supply power to the external devices in the fast charging mode through the output control modules 31.

It can be understood that in other examples, each transformer module 32 can be simultaneously connected to three or four output control modules 31. The control logic of the controller 33 can be changed to adapt to different connection methods, and is not specifically limited in the examples of the present application.

With reference to FIGS. 2-4, in a specific example, the control sub-circuit 311 includes a first switch circuit 3111 and a second switch circuit 3112, an input terminal of the first switch circuit 3111 is connected to the transformer module 32, and an output terminal of the first switch circuit 3111 is connected to an input terminal of the output port 31A. An input terminal of the second switch circuit 3112 is connected to a controlled terminal of the first switch circuit 3111, an output terminal of the second switch circuit 3112 is connected to a ground terminal of the output port 31A, and a controlled terminal of the second switch circuit 3112 is connected to the controller 33.

When it is detected (e.g., by the controller 33) that the output port 31A is connected to an external device, the controller 33 is configured to send a conduction signal to the second switch circuit 3112 in the output control module 31 corresponding to the connected external device, making the second switch circuit 3112 conductive, thereby making the first switch circuit 3111 conductive, enabling the transformer module 32 to supply power to the output port 31A via the first switch circuit 3111, and enabling the output port 31A to supply power to the external device in the fast charging mode.

With reference to FIGS. 2-4, in one example, the first switch circuit 3111 includes a first switch element Q1, a second switch element Q2, a first resistor R1, a first diode D1, and a second diode D2, where an input terminal of the first switch element Q1 is connected to an input terminal of the first switch circuit 3111. An input terminal of the second switch element Q2 is connected to an output terminal of the first switch element Q1, an output terminal of the second switch element Q2 is connected to an output terminal of the first switch circuit 3111, and a controlled terminal of the second switch element Q2 is connected to a controlled terminal of the first switch element Q1 and connected to a controlled terminal of the first switch circuit 3111. The first resistor R1 is connected to the output terminal and controlled terminal of the first switch element Q1. A positive electrode of the first diode D1 is connected to the input terminal of the first switch element Q1, and a negative electrode of the first diode D1 is connected to the output terminal of the first switch element Q1. A positive electrode of the second diode D2 is connected to the output terminal of the second switch element Q2, and a negative electrode of the second diode D2 is connected to the input terminal of the second switch element Q2.

After the controller 33 controls the second switch circuit 3112 to conduct, the transformer module 32 and the ground terminal of the output port 31A may be sequentially conducted via the first diode D1, the first resistor R1, and the second switch circuit 3112, so that a voltage drop is generated between two terminals of the first resistor R1, the first switch element Q1 and the second switch element Q2 are conducted, the output voltage of the transformer module 32 can supply power to the output port 31A via the first switch element Q1 and the second switch element Q2, and the output port 31A can supply power to the external device.

Further, the arrangement of the second diode D2 can prevent the output port 31A from being charged when the corresponding transformer module 32 supplies power to other output ports 31A, thereby reducing the probability of electric shock for users and providing reliable guarantee for users' safety. And such arrangement can reduce the power loss of the transformer module 32, improve the utilization of electric energy, and ensure that other output ports 31A can supply power to external devices in the fast charging mode.

It can be understood that both the first switch element Q1 and the second switch element Q2 may be at least one of a triode (Bipolar Junction Transistor, BJT), a field-effect transistor (Metal-Oxide-Semiconductor, MOS), and an electromagnetic relay. In the examples of the present application, the specific forms of the first switch element Q1 and the second switch element Q2 are not limited.

For example, both the first switch element Q1 and the second switch element Q2 may be field-effect transistors, the first diode D1 may be a parasitic diode of the first switch element Q1, and the second diode D2 may be a parasitic diode of the second switch element Q2.

With reference to FIGS. 2-4, specifically, the first switch element Q1 includes a first PMOS (P-Metal-Oxide-Semiconductor) transistor and a first parasitic diode, where a drain of the first PMOS transistor is connected to the input terminal of the first switch circuit 3111. A positive electrode of the first parasitic diode is connected to the drain of the first PMOS transistor, and a negative electrode of the first parasitic diode is connected to a source of the first PMOS transistor. The second switch element Q2 includes a second PMOS transistor and a second parasitic diode, where a source of the second PMOS transistor is connected to the drain of the first PMOS transistor, a drain of the second PMOS transistor is connected to the output terminal of the first switch circuit 3111, and a gate of the second PMOS transistor is connected to a gate of the first PMOS transistor. A positive electrode of the second parasitic diode is connected to the drain of the second PMOS transistor, and a negative electrode of the second parasitic diode is connected to a source of the second PMOS transistor. And the first resistor R1 is connected to the source and gate of the first PMOS transistor.

After the controller 33 controls the second switch circuit 3112 to conduct, the transformer module 32 and the output port 31A can be sequentially conducted via the first parasitic diode, the first resistor R1, and the second switch circuit 3112, so that a voltage drop is generated between the two terminals of the first resistor R1, the source voltage of the first PMOS transistor is higher than its gate voltage, the source voltage of the second PMOS transistor is also higher than its gate voltage, the source and drain of the first PMOS transistor are conducted, the source and drain of the second PMOS transistor are also conducted, the first switch circuit 3111 is conducted, and the transformer module 32 can supply power to the output port 31A via the first PMOS transistor and the second PMOS transistor.

It can be understood that the first switch element Q1 may alternatively be an NMOS (N-Metal-Oxide-Semiconductor) transistor, and the second switch element Q2 may alternatively be an NMOS transistor. Details will not be repeated here.

With reference to FIGS. 2-4, in an example, the second switch circuit 3112 includes a third switch element Q3 and a second resistor R2, where an input terminal of the third switch element Q3 is connected to the input terminal of the second switch circuit 3112, an output terminal of the third switch element Q3 is connected to the output terminal of the second switch circuit 3112, and a controlled terminal of the third switch element Q3 is connected to the controlled terminal of the second switch circuit 3112; and the second resistor R2 is connected to the output terminal and controlled terminal of the third switch element Q3.

When it is detected that the output port 31A is connected to an external device, the controller 33 is configured to send a conduction signal to the second switch circuit 3112 in the output control module 31 corresponding to the connected external device, so that a voltage difference is generated between two terminals of the second resistor R2, the third switch element Q3 is conducted, the gates of the first PMOS transistor and the second PMOS transistor are conducted with the ground terminal of the output port 31A via the third switch element Q3, a voltage drop is generated between the two terminals of the first resistor R1, the first PMOS transistor and the second PMOS transistor are conducted, the output voltage of the transformer module 32 can supply power to the output port 31A via the first PMOS transistor and the second PMOS transistor, and the output port 31A can supply power to the external device.

It can be understood that the third switch element Q3 may be at least one of a triode, a field-effect transistor, and an electromagnetic relay. In the examples of the present application, the specific form of the third switch element Q3 is not limited.

For example, the third switch element Q3 may be a field-effect transistor. Specifically, the first switch element Q1 may be an NMOS transistor, a drain of the NMOS transistor is the input terminal of the third switch element Q3, a source of the NMOS transistor is the output terminal of the third switch element Q3, and a gate of the NMOS transistor is the controlled terminal of the third switch element Q3. When the controller 33 sends a conduction signal to the second switch circuit 3112, the conduction signal can result in a voltage drop between the two terminals of the second resistor R2, so that the gate voltage of the NMOS transistor is greater than its source voltage, the source and drain of the NMOS transistor are conducted, the gates of the first PMOS transistor and the second PMOS transistor are conducted with the ground terminal of the output port 31A via the NMOS transistor, the first switch circuit 3111 is conducted, and the transformer module 32 can supply power to the output port 31A via the first PMOS transistor and the second PMOS transistor.

It can be understood that the third switch element Q3 may alternatively be a PMOS transistor. Details will not be repeated here.

With reference to FIGS. 2-4, the control sub-circuit 311 further includes a third resistor R3, the third resistor R3 is connected to the controlled terminal of the first switch circuit 3111 and the input terminal of the second switch circuit 3112, and the resistance of the third resistor R3 is several hundred kiloohms, so that the resistance in a ground terminal loop from the transformer module 32 to the output port 31A via the first parasitic diode, the third resistor R3, and the third switch element Q3 is much greater than the resistance in an output terminal loop from the transformer module 32 to the output port 31A via the first switch circuit 3111, the current in the ground terminal loop from the transformer module 32 to the output port 31A via the first parasitic diode, the third resistor R3, and the third switch element Q3 is relatively low, the electric energy loss in this loop is relatively low to reduce the overall electric energy loss of the control sub-circuit 311, the energy utilization of the multi-port output control circuit 3 is relatively high, and the energy utilization of the charging apparatus 1 is relatively high.

It can be understood that, if the quantity of external devices connected to the charging apparatus 1 is greater than that of transformer modules 32, the charging apparatus 1 can obtain the charging power and remaining power of each external device through handshake communication, and allocate the output power of each output port 31A reasonably.

For example, when the same transformer module 32 is connected to two external devices, the charging apparatus 1 can obtain the rated charging power and remaining power of the two external devices through handshake communication, control the output power of the output port 31A connected to the external device with higher power to decrease, and control the output power of the output port 31A connected to the external device with lower power to increase, thereby improving the charging efficiency of the charging apparatus 1 for the external device with lower power, improving the charging efficiency of the charging apparatus 1 for the external devices, and also improving the energy utilization of the charging apparatus 1.

For example, when the same transformer module 32 is connected to two external devices, the charging apparatus 1 can obtain the rated charging power and remaining power of the two external devices through handshake communication. If the charging apparatus 1 detects that one of the external devices is disconnected from the output port 31A, the charging apparatus 1 can control the transformer module 32 to supply power to the other external device in the fast charging mode, so as to improve the charging efficiency of the charging apparatus 1 for the other external device.

It can be understood that the charging apparatus 1 may allocate power in other forms when the same transformer module 32 supplies power to at least two external devices. These forms are not specifically limited in the examples of the present application.

The same or similar reference numerals in the accompanying drawings of the examples correspond to the same or similar components. In the description of the present application, it should be understood that if the terms such as “up”, “down”, “left”, and “right” indicate orientations or positional relationships based on the orientations or positional relationships shown in the accompanying drawings, it is only for the convenience of describing the present application and simplifying the description, and does not indicate or imply that the device or component referred to must have a specific orientation or be constructed and operated in a specific orientation. Therefore, the terms for describing the positional relationships in the accompanying drawings are only for illustrative description and cannot be understood as limitations of this patent. Those of ordinary skill in the art can understand the specific meanings of the above terms according to specific situations.

Described above are merely the preferred examples of the present application, which are not used for limiting the present application. Any modification, equivalent replacement and improvement, and the like made within the spirit and principle of the present application shall fall within the protection scope of the present application.

What is claimed is:

1. A multi-port output control circuit, comprising:
N output control modules, each of the output control modules comprising an output port configured to be connected to an external device;
M transformer modules, each of the transformer modules being connected to at least two of the output control modules, wherein M<N; and
a controller configured to control the output control modules,
wherein based on a number of external devices simultaneously connected to the output ports not exceeding M, the transformer modules are configured to supply power to the external devices through the output control modules.

2. The multi-port output control circuit according to claim 1, wherein each of the output control modules further comprises:
a control sub-circuit connected to the respective output port, one of the transformer modules, and the controller.

3. The multi-port output control circuit according to claim 2, wherein when N=4 and M=2, each of the output control modules comprises two control sub-circuits, and the two control sub-circuits are connected to the respective output port and the controller, and are connected to the two transformer modules respectively; and
wherein when at most two output ports are connected to the external devices, the controller is configured to control the corresponding output control modules to conduct current, and the transformer modules are configured to supply power to the external devices through the output control modules.

4. The multi-port output control circuit according to claim 2, wherein when N=4 and M=3,
the four output control modules comprise a first output control module, a second output control module, a third output control module, and a fourth output control module;
each of the first output control module and the fourth output control module has one control sub-circuit;
each of the second output control module and the third output control module has two control sub-circuits;
the three transformer modules comprise a first transformer module, a second transformer module, and a third transformer module;
the first transformer module is connected to the control sub-circuit of the first output control module and one of the two control sub-circuits in the second output control module;
the second transformer module is connected to the other control sub-circuit in the second output control module and one of the two control sub-circuits in the third output control module;
the third transformer module is connected to the other control sub-circuit in the third output control module and the control sub-circuit in the fourth output control module; and
when at most three output ports are connected to the external devices, the controller is configured to control the corresponding output control modules to conduct current, and the transformer modules are configured to supply power to the external devices through the output control modules.

5. The multi-port output control circuit according to claim 2, wherein the control sub-circuit comprises:
a first switch circuit, wherein an input terminal of the first switch circuit is connected to the one of the transformer modules, and an output terminal of the first switch circuit is connected to an input terminal of the respective output port; and
a second switch circuit, wherein an input terminal of the second switch circuit is connected to a controlled terminal of the first switch circuit, an output terminal of the second switch circuit is connected to a ground terminal of the respective output port, and a controlled terminal of the second switch circuit is connected to the controller.

6. The multi-port output control circuit according to claim 5, wherein the first switch circuit comprises:
a first switch, wherein an input terminal of the first switch is connected to the input terminal of the first switch circuit;
a second switch, wherein an input terminal of the second switch is connected to the output terminal of the first switch, an output terminal of the second switch is connected to the output terminal of the first switch circuit, and a controlled terminal of the second switch is connected to a controlled terminal of the first switch and connected to the controlled terminal of the first switch circuit;
a first resistor connected to the output terminal and controlled terminal of the first switch;
a first diode, wherein a positive electrode of the first diode is connected to the input terminal of the first switch, and a negative electrode of the first diode is connected to the output terminal of the first switch; and
a second diode, wherein a positive electrode of the second diode is connected to the output terminal of the second switch, and a negative electrode of the second diode is connected to the input terminal of the second switch.

7. The multi-port output control circuit according to claim 5, wherein the first switch circuit comprises:
a first switch, wherein the first switch comprises a first p-metal-oxide-semiconductor (PMOS) transistor and a first parasitic diode, a drain of the first PMOS transistor is connected to the input terminal of the first switch circuit, a positive electrode of the first parasitic diode is connected to the drain of the first PMOS transistor, and a negative electrode of the first parasitic diode is connected to a source of the first PMOS transistor;
a second switch, wherein the second switch comprises a second PMOS transistor and a second parasitic diode, a source of the second PMOS transistor is connected to the drain of the first PMOS transistor, a drain of the second PMOS transistor is connected to the output terminal of the first switch circuit, a gate of the second PMOS transistor is connected to a gate of the first PMOS transistor, a positive electrode of the second parasitic diode is connected to the drain of the second PMOS transistor, and a negative electrode of the second parasitic diode is connected to the source of the second PMOS transistor; and
a first resistor connected to the source and gate of the first PMOS transistor.

8. The multi-port output control circuit according to claim 5, wherein the second switch circuit comprises:
a third switch, wherein an input terminal of the third switch is connected to the input terminal of the second switch circuit, an output terminal of the third switch is connected to the output terminal of the second switch circuit, and a controlled terminal of the third switch is connected to the controlled terminal of the second switch circuit; and
a second resistor, connected to the output terminal and controlled terminal of the third switch.

9. The multi-port output control circuit according to claim 5, wherein the control sub-circuit further comprises:
a third resistor, connected to the controlled terminal of the first switch circuit and the input terminal of the second switch circuit.

10. The multi-port output control circuit according to claim 1, wherein when more than M output ports are connected to the external devices, at least one of the transformer modules is configured to supply power to the external devices through at least two of the output control modules.

11. A power circuit, comprising:
a rectifier module comprising an alternating current input terminal and a direct current output terminal, wherein the alternating current input terminal of the rectifier module is configured to be connected to a power source;
a multi-port output control circuit comprising:
N output control modules, each of the output control modules comprising an output port configured to be connected to an external device;
M transformer modules, each of the transformer modules being connected to at least two of the output control modules, wherein M<N, and wherein an input terminal of each of the transformer modules is connected to the direct current output terminal of the rectifier module; and
a protocol chip, connected to each of the transformer modules and each of the output ports.

12. A charging apparatus, comprising:
a multi-port output control circuit, comprising:
N output control modules, each of the output control modules comprising an output port configured to be connected to an external device;
M transformer modules, each of the transformer modules being connected to at least two of the output control modules, wherein M<N; and
a controller configured to control the output control modules,
wherein based on a number of external devices simultaneously connected to the output ports not exceeding M, the transformer modules are configured to supply power to the external devices through the output control modules.

13. The charging apparatus according to claim 12, further comprising:
a shell with a power interface; and
a circuit board disposed inside the shell, wherein the circuit board comprises the multi-port output control circuit.

14. The charging apparatus according to claim 12, wherein each of the output control modules further comprises:
a control sub-circuit connected to the respective output port, one of the transformer modules, and the controller.

15. The charging apparatus according to claim 14, wherein when N=4 and M=2, each of the output control modules comprises two control sub-circuits, and the two control sub-circuits are connected to the respective output port and the controller, and are connected to the two transformer modules respectively; and
wherein when at most two output ports are connected to the external devices, the controller is configured to control the corresponding output control modules to conduct current, and the transformer modules are configured to supply power to the external devices through the output control modules.

16. The charging apparatus according to claim 14, wherein when N=4 and M=3,
the four output control modules comprise a first output control module, a second output control module, a third output control module, and a fourth output control module;
each of the first output control module and the fourth output control module has one control sub-circuit;
each of the second output control module and the third output control module has two control sub-circuits;
the three transformer modules comprise a first transformer module, a second transformer module, and a third transformer module;
the first transformer module is connected to the control sub-circuit of the first output control module and one of the two control sub-circuits in the second output control module;
the second transformer module is connected to the other control sub-circuit in the second output control module and one of the two control sub-circuits in the third output control module;
the third transformer module is connected to the other control sub-circuit in the third output control module and the control sub-circuit in the fourth output control module; and
when at most three output ports are connected to the external devices, the controller is configured to control the corresponding output control modules to conduct current, and the transformer modules are configured to supply power to the external devices through the output control modules.

17. The charging apparatus according to claim 14, wherein the control sub-circuit comprises:
a first switch circuit, wherein an input terminal of the first switch circuit is connected to the one of the transformer modules, and an output terminal of the first switch circuit is connected to an input terminal of the respective output port; and
a second switch circuit, wherein an input terminal of the second switch circuit is connected to a controlled terminal of the first switch circuit, an output terminal of the second switch circuit is connected to a ground terminal of the respective output port, and a controlled terminal of the second switch circuit is connected to the controller.

18. The charging apparatus according to claim 17, wherein the first switch circuit comprises:
a first switch, wherein an input terminal of the first switch is connected to the input terminal of the first switch circuit;
a second switch, wherein an input terminal of the second switch is connected to the output terminal of the first switch, an output terminal of the second switch is connected to the output terminal of the first switch circuit, and a controlled terminal of the second switch is connected to a controlled terminal of the first switch and connected to the controlled terminal of the first switch circuit;
a first resistor connected to the output terminal and controlled terminal of the first switch;
a first diode, wherein a positive electrode of the first diode is connected to the input terminal of the first switch, and a negative electrode of the first diode is connected to the output terminal of the first switch; and
a second diode, wherein a positive electrode of the second diode is connected to the output terminal of the second switch, and a negative electrode of the second diode is connected to the input terminal of the second switch.

19. The charging apparatus according to claim 17, wherein the first switch circuit comprises:
a first switch, wherein the first switch comprises a first p-metal-oxide-semiconductor (PMOS) transistor and a first parasitic diode, a drain of the first PMOS transistor is connected to the input terminal of the first switch circuit, a positive electrode of the first parasitic diode is connected to the drain of the first PMOS transistor, and a negative electrode of the first parasitic diode is connected to a source of the first PMOS transistor;
a second switch, wherein the second switch comprises a second PMOS transistor and a second parasitic diode, a source of the second PMOS transistor is connected to the drain of the first PMOS transistor, a drain of the second PMOS transistor is connected to the output terminal of the first switch circuit, a gate of the second PMOS transistor is connected to a gate of the first PMOS transistor, a positive electrode of the second parasitic diode is connected to the drain of the second PMOS transistor, and a negative electrode of the second parasitic diode is connected to the source of the second PMOS transistor; and
a first resistor connected to the source and gate of the first PMOS transistor.

20. The charging apparatus according to claim 12, wherein when more than M output ports are connected to the external devices, at least one of the transformer modules is configured to supply power to the external devices through at least two of the output control modules.
